(19) United States
(12) Patent Application Publication
(10) Pub. No.: US 2026/0346327 A1
(43) Pub. Date: Nov. 5, 2026

(54) METHOD FOR MANUFACTURING A HOLLOW TURBINE VANE FOR A TURBINE ENGINE

(71) Applicant: SAFRAN AIRCRAFT ENGINES, Paris (FR)

(72) Inventors: Antoine DOUIN, MOISSY-CRAMAYEL (FR); Lucas FERREIRA MONTERO, MOISSY-CRAMAYEL (FR); Jonathan BERCOT, MOISSY-CRAMAYEL (FR)

(73) Assignee: SAFRAN AIRCRAFT ENGINES, Paris (FR)

(21) Appl. No.: 19/485,963

(22) PCT Filed: May 15, 2024
(86) PCT No.: PCT/FR2024/050631

§ 371 Date: Nov. 19, 2025

(30) Foreign Application Priority Data
May 22, 2023 (FR) FR2305028

(51) Int. Cl. B22D 19/00; B22C 7/02; B22C 9/06; F01D 5/18

(52) U.S. Cl. CPC B22D 19/00; B22C 7/02; B22C 9/065; F01D 5/18; F05D 2230/20

(57) ABSTRACT

A method for manufacturing a hollow turbine blade for a turbine engine with pressure-side and suction-side walls that are passed through by internal cooling channels includes at least one first moulding phase employing the lost-wax casting technique using a molten metal. The first moulding phase includes at least one step of manufacturing a mould made of refractory material, the internal walls of which match the external shape of the blade to be manufactured. In the at least one step, a plurality of projections defining outlet opening counterforms of the internal cooling channels are formed on the internal walls of the mould made of refractory material.

### FIELD OF THE DISCLOSURE

The disclosure relates to the general field of turbine vanes for turbine engine, and more specifically to hollow turbine vanes equipped with integrated cooling circuits produced by the lost wax casting technique.

### BACKGROUND

In a known way, a turbine engine comprises a combustion chamber wherein air and fuel are mixed before being burnt. The gases produced by this combustion flow downstream of the combustion chamber and then supply a high-pressure turbine and a low-pressure turbine. Each turbine comprises one or more rows of stationary vanes (referred to turbine stator vane) alternating with one or more rows of movable vanes (referred movable wheels), mounted and spaced circumferentially around the rotor of the turbine. These turbine vanes are subjected to the very high temperatures of the combustion gases, which reach values well above those that the vanes, which are in direct contact with these gases, may withstand without damage, which has the effect of limiting their service life.

In order to solve this problem, it is known to equip these vanes with internal cooling circuits with high levels of thermal efficiency aimed at reducing their temperature. To achieve this, the vanes are hollow and a circulation of air is organized inside their internal cavities, this air is generally supplied by a pressurization circuit for the internal enclosures of the turbines, this circuit itself being supplied by one or more of the compressors of the turbine engine.

The vanes comprise known pressure side and suction side walls. In addition to their internal cavities, the vanes also comprise internal perforations which pass through these walls and open onto the external surfaces of these walls. The air ejected through the internal channels generates a layer of air protecting the surface of the vane. In order to optimize this layer of air, the internal channels do not open directly onto the surface of the pressure side and suction side walls, but rather by means of outlet openings extending from each internal channel. The purpose of these outlet openings, referred as “shaped holes”, is to incline and direct the flow of air from each channel so that it flows in a laminar flow over the surface of the vane, thereby improving its insulation.

The manufacture of cast vanes is a complex process that requires the use of a ceramic core to create these internal cavities during the casting of the wax and then the molten metal.

The application WO2016/151234 in the name of the applicant shows a ceramic core allowing all the internal cavities of a vane to be produced in a single element and thus ensuring particularly effective internal cooling without significantly increasing the flow rate of cooling air and therefore without penalizing engine performance.

The internal channels, as also described in FR-A1-2 961 552, are generally produced by laser drilling or EDM (electrical discharge machining). The outlet openings, caps or shaped holes are made using the same conventional processes.

Also known from the prior art are the documents US-2013-0139990-A1, US-2007-0175009-A1, US-2013-0333855-A1 and U.S. Pat. No. 8,066,052-B2.

Conventionally, to manufacture the vane, it is first molded using a lost wax molding method. The internal channels of the vane are then created in one step, using laser drilling or EDM. Finally, in the next step, the outlet openings are created by EDM on the existing internal channels.

During these two steps, the positioning coordinates of the laser or EDM drilling tool are expressed in a three-dimensional reference frame using reference points located on the root of the vane as reference points, which are therefore quite far from the channels and caps to be produced. This distance leads to dispersions in the positioning of the channels and outlet openings and problems with the reproducibility of the position of internal channels and outlet openings. As a result, finished parts may have a number of internal channels that do not open into the outlet openings but directly into the external surfaces of the pressure side and suction side walls, and conversely, some outlet openings may be blind. A vane with such defects must be scrapped. In addition, this lack of reproducibility results in a deviation from the nominal position of the outlet openings as calculated using a nominal model. As a result, the cooling performance is reduced by deviating from this nominal model.

There is therefore a real need for a method for manufacturing the vane that guarantees a reproducible positioning of the outlet openings.

### SUMMARY

The present disclosure therefore aims to overcome the disadvantages associated with these non-conformities in the positioning of the outlet openings by proposing a method for manufacturing the vane that allows the outlet ports to be produced directly during the molding of the vane.

To this end, the disclosure proposes a method for manufacturing a hollow turbine vane for a turbine engine, this hollow vane comprising pressure side and suction side walls, at least one of which is passed through by internal cooling channels, the method comprising at least a first molding phase using the lost-wax casting technique using a molten metal, the first molding phase 1) comprising the following steps:
a) manufacturing at least one ceramic core defining at least one counter-form of at least one internal cavity of the vane to be manufactured,
b) manufacturing a mold made of refractory material, the internal walls of which match to the external shape of the vane to be manufactured,
c) placing the core in the mold made of refractory material,
d) casting a lost wax in the mold made of refractory material between the core and its internal walls,
e) once the wax has solidified, opening the mold and removing the assembly made by the core trapped in the solidified lost wax,
f) forming on the assembly a ceramic shell matching to an external shape of the assembly,
g) removing the lost wax from the ceramic shell,
h) casting molten metal in a space left free between the core and the shell by the removal of the lost wax,
i) opening or destructing the ceramic shell,
j) removing the ceramic core so as to obtain a cast blank of the hollow turbine vane, characterized in that, during step b), a plurality of protuberances are formed on the internal walls of the mold made of refractory material, defining counter-forms of outlet openings for the internal cooling channels.

The advantage of this method is that it guarantees a reproducible position for the outlet openings. They may therefore be used as reference points for positioning the internal cooling channels.

According to other characteristics of the method:
each protuberance defines the counter-form of an outlet opening in the form of a flared bowl,
each protuberance extends along a main elongation axis and has at least:
   a first substantially trapezoidal face having a large base joined to the internal wall of the mold and a height oriented parallel to the main elongation axis, this first face being inclined at an angle of less than 30 degrees to the internal wall of the mold,
   a substantially rectangular second face, aligned with the first face along the main elongation axis and joined to a small base of the first face, this second face being inclined at an angle greater than 80 degrees and less than 90 degrees to the internal wall of the mold, and
two third and fourth substantially triangular lateral faces bordering the first and second faces,
   the first to fourth faces defining the counter-form of the flared bowl,

According to a first embodiment of the method, during step a), the core is manufactured with a plurality of spikes defining counter-forms of the internal cooling channels, the spikes being of a determined length configured so that, during step c), the spikes come into contact with the protuberances, so that, during step j), the cast blank of the hollow turbine vane directly incorporates those channels communicating with the outlet openings.

This first embodiment of the method allows the internal channels to be produced at the same time as the outlet openings and the rest of the vane.

According to this first embodiment of the method, the spikes are oriented to contact the protuberances at the junction of the first and second faces of the protuberances.

According to a second embodiment of the method, it comprises, after the first molding phase, a second machining phase, which comprises a step k) during which a bottom of the outlet openings of the cast blank of the vane is drilled in order to form the internal cooling channels.

This second embodiment of the method allows the outlet openings to be used to define a reference point for positioning the tool used to create the internal cooling channels.

According to this second embodiment of the method, step k) is carried out by electro erosion using a sinker EDM tool or a drilling tool.

Advantageously, during step k), position and displacement coordinates of the tool are expressed in a reference frame comprising 3 reference points, these points all belonging to at least one outlet opening.

The disclosure also relates to a mold made of refractory material for implementing a manufacturing method of the type described above, characterized in that the protuberances are formed in one-part with the internal walls of the mold made of refractory material.

The disclosure also relates to a mold made of refractory material as an alternative for implementing a manufacturing method of the type described above, characterized in that the protuberances are fitted and attached to the internal walls of the mold made of refractory material.

Finally, the disclosure relates to a turbine engine vane manufactured using a method as described above.

### DESCRIPTION OF THE DRAWINGS

Further characteristics and advantages of the disclosure will become apparent from the following detailed description, for the understanding of which reference is made to the attached drawings wherein:

FIG. 1 is a perspective view of a turbine engine vane according to the disclosure;

FIG. 2 is a detailed perspective view of an outlet opening and internal channel formed in a wall of the vane of FIG. 1;

FIG. 3 is a top view of a protuberance forming the counter-form of an outlet opening in FIG. 1;

FIG. 3a is a schematic partial perspective view of a part of a mold configured to be located on the side of a suction side of the vane to be formed;

FIG. 3b is a schematic partial perspective view of a part of a mold configured to be located on the side of a pressure side of the vane to be formed;

FIG. 4 is a schematic view illustrating a first step in the manufacture of a ceramic core defining at least one counter-form of an internal cavity of the vane of FIG. 1 as part of a method according to a first embodiment of the disclosure,

FIG. 5 is a schematic view illustrating a second step of placing the core in a mold made of refractory material, the internal walls of which match the external shape of the vane in FIG. 1, as part of the method according to the first embodiment of the disclosure,

FIG. 6 is a schematic view illustrating a third step of casting a lost wax in the mold made of refractory material between the core and its internal walls as part of the method according to the first embodiment of the disclosure,

FIG. 7 is a schematic view illustrating a fourth step in removing the assembly formed by the core trapped in the solidified lost wax as part of the method according to the first embodiment of the disclosure,

FIG. 8 is a schematic view illustrating a fifth step of forming on this assembly a ceramic shell matching to an external shape of the assembly as part of the method according to the first embodiment of the disclosure,

FIG. 9 is a schematic view illustrating a sixth step in removing the lost wax from the ceramic shell as part of the method according to the first embodiment of the disclosure,

FIG. 10 is a schematic view illustrating a seventh step of casting molten metal into a space left free between the core and the shell as part of the method according to the first embodiment of the disclosure,

FIG. 11 is a schematic view illustrating an eighth step in destroying the shell as part of the method according to the first embodiment of the disclosure,

FIG. 12 is a schematic view illustrating a ninth step of removing the ceramic core in order to obtain a cast blank of the hollow turbine vane as part of the method according to the first embodiment of the disclosure,

FIG. 13 is a block diagram illustrating the steps in the method according to the first embodiment of the disclosure,

FIG. 14 is a schematic view illustrating a first step in the manufacture of a ceramic core defining at least one counter-form of an internal cavity of the vane of FIG. 1 as part of a method according to a second embodiment of the disclosure,

FIG. 15 is a schematic view illustrating a second step of placing the core in a mold made of refractory material, the internal walls of which match the external shape of the vane in FIG. 1, as part of the method according to the second embodiment of the disclosure,

FIG. 16 is a schematic view illustrating a third step of casting a lost wax in the mold made of refractory material between the core and its internal walls as part of the method according to the second embodiment of the disclosure,

FIG. 17 is a schematic view illustrating a fourth step in removing the assembly formed by the core trapped in the solidified lost wax as part of the method according to the second embodiment of the disclosure,

FIG. 18 is a schematic view illustrating a fifth step of forming on this assembly a ceramic shell matching to an external shape of the assembly as part of the method according to the second embodiment of the disclosure,

FIG. 19 is a schematic view illustrating a sixth step in removing the lost wax from the ceramic shell as part of the method according to the second embodiment of the disclosure,

FIG. 20 is a schematic view illustrating a seventh step of casting molten metal into a space left free between the core and the shell as part of the method according to the second embodiment of the disclosure,

FIG. 21 is a schematic view illustrating an eighth step in destroying the shell as part of the method according to the second embodiment of the disclosure,

FIG. 22 is a schematic view illustrating a ninth step of removing the ceramic core in order to obtain a cast blank of the hollow turbine vane and drilling the internal pipes as part of the method according to the second embodiment of the disclosure, and

FIG. 23 is a block diagram illustrating the steps in the method according to the second embodiment of the disclosure.

### DETAILED DESCRIPTION

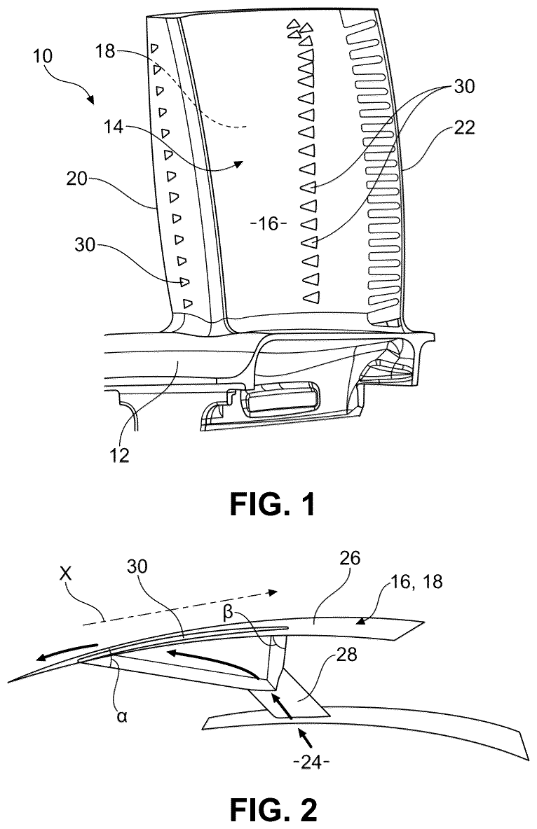

FIG. 1 shows a hollow turbine vane 10 for a turbine engine. In a known way, such a vane 10 comprises a root 12 which is configured to be received in a turbine rotor disc (not shown) and a blade 14 which extends from this root. The blade 14 comprises two walls, a pressure side 16 and a suction side 18, which join at one end of the blade 14 at a leading edge 20 and at an opposite downstream end of the blade at a trailing edge 22.

Inside the vane 10 there is at least one internal cavity 24, shown schematically in FIG. 12, which is configured to allow the circulation of a flow of cooling air configured to cool the turbine vane in order to preserve its integrity, as the vane is bathed in a flow of hot gases from the combustion chamber of the turbine engine and must be cooled.

The flow of cooling air comes from an internal pressurization circuit for the enclosures of the turbine engine, this internal pressurization circuit being supplied with pressurized air from at least one tap on a compressor of the turbine engine.

As illustrated in FIGS. 2, 12 and 22, the cavity 24 communicates with an external surface 26 of the pressure side 16 or suction side 18 wall by means of a plurality of cooling internal channels 28. The presence of these channels means that the external surface of the vane 10 is bathed in a flow of cooling air, limiting the effect of hot gases on the external surfaces 26 of the vane 10.

In order for this flow of cooling gas to be as efficient as possible, it is important, on the one hand, to increase the number of internal channels 28 and, on the other hand, that these do not open directly into the surfaces 26, but via outlet openings 30. These outlet openings 30, also referred as caps and visible in FIGS. 1 and 2, allow the air flow to be directed in a laminar flow substantially at the outlet of the surface 26. To this end, as shown in FIG. 2, each outlet opening 30 has a flared shape.

Conventionally, to manufacture such a vane 10, the vane 10 provided with its internal cavity 24 is first manufactured in a first molding phase by a lost wax molding method. The internal channels 28 are then created by laser drilling or electrical discharge machining (EDM). Finally, the outlet openings 30 are created by EDM on the existing internal channels 28.

During these two steps of manufacturing the channels 28 and openings 30, the coordinates of the positioning of the laser or EDM drilling tools are expressed in a three-dimensional reference frame taking as reference points of the points located on the root 12 of the vane 10, which are consequently quite far from the channels 28 and outlet openings 30 to be produced. This distance leads to dispersions in the relative positioning of the channels 28 and the outlet openings and problems with the reproducibility of the position of the internal channels 28 and the outlet openings 30. As a result, a number of internal channels 28 on finished vanes may not open into the outlet openings 30 but directly into the external surfaces 26 and, conversely, some outlet openings 30 may be blind. A vane 10 with such defects must then be discarded because the cooling of its surface 26 may not be carried out correctly.

There is therefore a real need for a method for manufacturing the vane 10 that guarantees a reproducible positioning of the outlet openings 30 in relation to the internal channels 28. The disclosure allows to achieve this aim by proposing a manufacturing method wherein the outlet openings 30 are produced simultaneously with the molding of the vane 10.

The steps in a method for manufacturing a vane 10 using this method are shown in a first embodiment in FIGS. 4 to 13 and in a second embodiment in FIGS. 14 to 23.

The two embodiments of the manufacturing method have characteristics in common.

According to the disclosure, the method comprises at least a first molding phase PH1, shown in FIGS. 4 to 23, according to the lost wax casting technique using a molten metal.

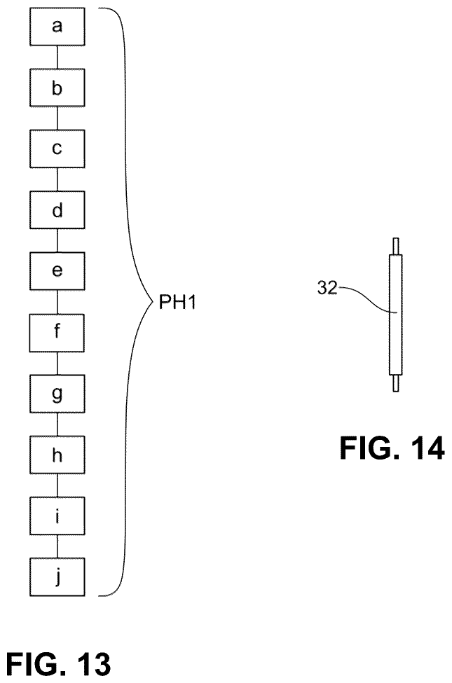

As illustrated in FIGS. 13 and 23, this molding phase firstly comprises a first step a) shown in FIGS. 4 and 14, during which at least one ceramic core 32 is produced, defining at least one counter-form of the at least one internal cavity 24 of the vane 10 to be produced.

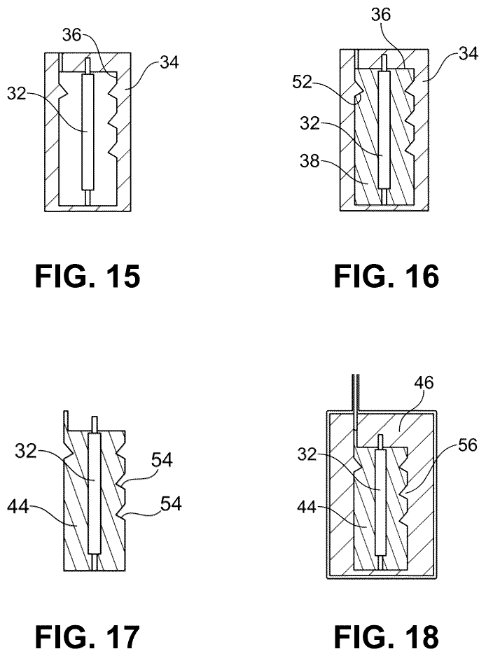

Then, in a step b) shown in FIGS. 13 and 23, a mold 34 is made of refractory material, the internal walls 36 of which match the external shape of the vane 10 to be manufactured. As shown in FIGS. 5 and 15, the core 32 is placed in this mold 34 made of refractory material during step c).

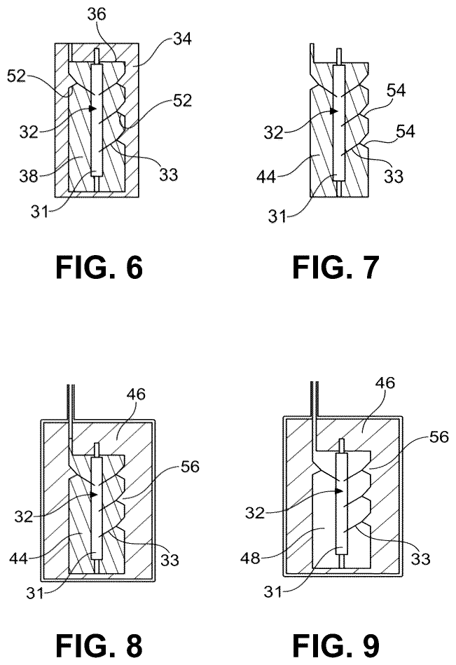

Then, as illustrated in FIGS. 6 and 16, in a step d) shown in FIGS. 13 and 23, a lost wax 38 is casted into the mold 34 made of refractory material, between the core 32 and the internal walls 36 of the mold 34.

Then, as shown in FIGS. 7 and 17, once the wax has solidified, in step e) the mold is opened and the assembly 32 formed by the core trapped in the solidified lost wax 44 is removed.

As illustrated in FIGS. 8 and 18, in a step f) shown in FIGS. 13 and 23, a ceramic shell 46 is formed on this assembly, which matches to an external shape of this assembly 32, 44.

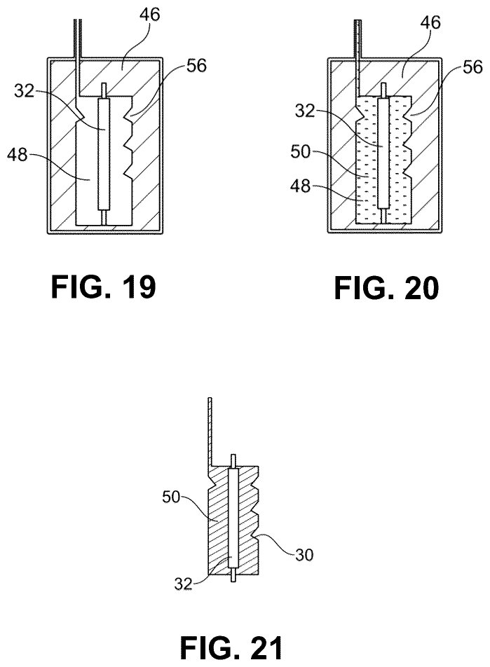

Then, as illustrated in FIGS. 9 and 19, in a step g) shown in FIGS. 13 and 23, the lost wax is removed from the ceramic shell 46. This leaves only a free space 45 between the core 32 and the shell 46. This removal is usually performed by melting the lost wax placing the assembly in an oven.

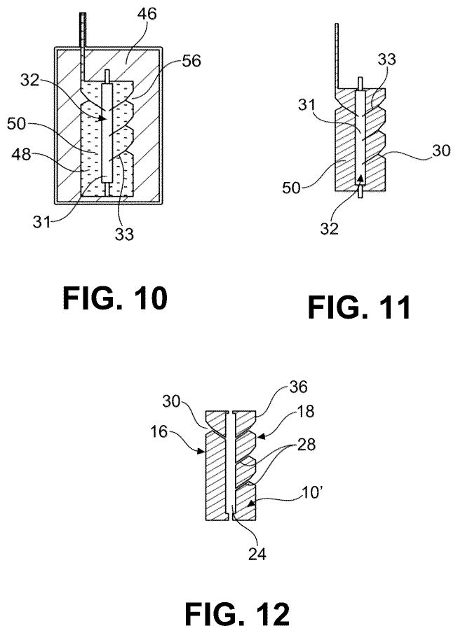

Then, in a step h) shown in FIGS. 10 and 20, a molten metal 50 is casted into the space 48 left free between the core 32 and the shell 46 by the removal of the lost wax.

Then, in a step i) shown in FIGS. 11 and 21, the shell 46 is opened or destroyed. All that remains is the core 32 trapped in the solidified metal 50.

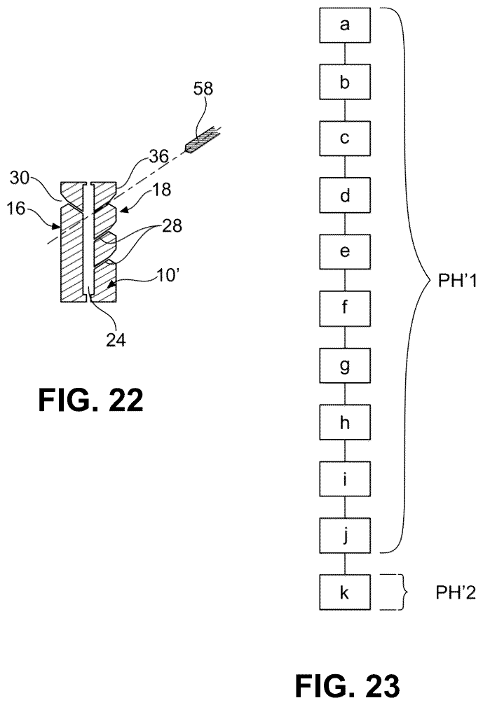

Finally, in a step j) shown in FIGS. 12 and 22, the ceramic core 32 is removed to obtain a cast blank 10′ of the hollow turbine vane. Removal is generally performed by chemical dissolution in an autoclave, sometimes combined with immersion of the part in an ultrasound bath.

These steps a) to j), which are known in the prior art, correspond to the conventional steps for manufacturing a cast blank 10′ for a vane.

The disclosure takes advantage of these steps to produce the outlet openings 30 directly during the molding phase.

To this end, as illustrated in FIGS. 5, 6 and 15, 16, during step b) which has been represented in FIGS. 13 and 23, a plurality of protuberances 52 are formed on the internal walls 36 of the mold 34 made of refractory material, defining counter-forms of the outlet openings 30 of the internal cooling channels.

As may be seen in FIGS. 7 and 17, these protuberances 52 define cavities 54 on the surface of the assembly comprising the core 32 trapped in the wax 44, cavities 54 which define new protuberances 56 inside the shell 46 as shown in FIGS. 8 to 10 and 18 to 20. These protuberances 56 in turn define the outlet openings 30 on the cast blank 10′, as shown in FIGS. 11, 12 and 21, 22.

In this way, by playing with forms and counter-forms, it is possible to easily obtain the outlet openings 30.

The two embodiments of the method differ in the way the internal channels 28 are manufactured.

According to the first embodiment of the disclosure shown in FIGS. 4 to 13, the internal channels 28 are also produced during the first molding phase PH1.

According to this first embodiment, during step a), the core 32 is manufactured with a central part 31 and a plurality of spikes 33 defining the counter-forms of the internal cooling channels 28.

The spikes 33 are of specific dimensions, advantageously consisting of alumina rods or quartz tubes, positioned on the central part 31 of the core (the various columns) configured to form the assembly of the internal channels 28 passing through the pressure side 16 and suction side 18 walls of the vane.

The ceramic core 32 bristling with spikes 33 is therefore referred to as a “hedgehog core”.

The spikes 33 are of a specific length configured so that, during step c) of FIG. 5, the spikes 33 come into contact with the protuberances 52, so that, during step j) of FIG. 12, the cast blank 10′ of the hollow turbine vane directly integrates the channels 28 communicating with the outlet openings 30.

To this end, the spikes 33 are oriented so that they touch the protuberances 52. This ensures continuity between the channels 28 and the outlet openings 30 on the blank 10′.

On the other hand, according to the second embodiment of the disclosure shown in FIGS. 14 to 23, the internal channels 28 are produced during a second machining phase PH′2 after a first molding phase PH′1. The steps in the molding phase PH′1 of FIGS. 14 to 21 are substantially identical to those in phase PH1 of the first embodiment of the disclosure, with the difference that the core 32 does not comprise any spikes.

As shown in FIGS. 22 and 23, this second embodiment of the method comprises, after the first molding phase PH′1, a second machining phase PH′2, which comprises a step k) during which a tool 58 is used to drill a bottom of the outlet openings 30 of the cast blank 10′ of the vane in order to form the internal cooling channels 28. This tool 58 is for example an EDM tool or a drilling tool such as a drill.

In a second embodiment of the disclosure, the prior manufacture by molding of the outlet openings 30 advantageously allows them to be used as a reference. Whereas in the prior art, the positioning and displacement coordinates of an EDM or drilling tool were expressed in a frame of reference comprising 3 reference points belonging to the root 12 of the vane, here during step k), these tool position and displacement coordinates are expressed in a frame of reference comprising 3 reference points, all belonging to at least one outlet opening 30. This ensures more accurate positioning of the tool 58, thus avoiding positional shifts between the channels 28 and the outlet openings 30.

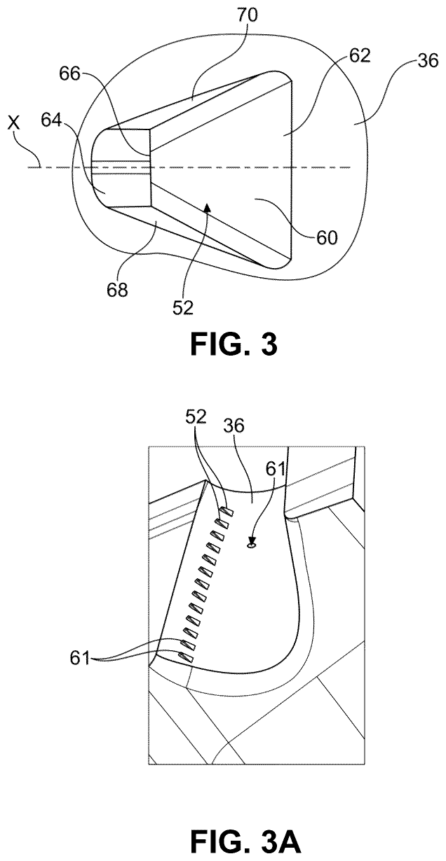

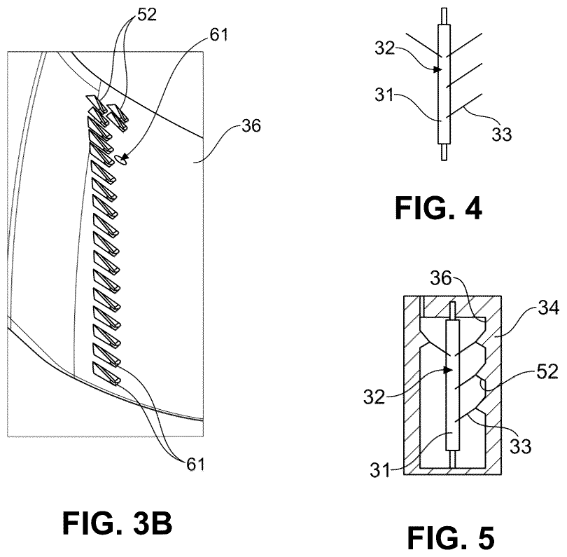

As illustrated in FIGS. 2 and 3, each protuberance defines the counter-form of a flared bowl-shaped outlet opening 30. It is desirable for the outlet opening 30 to have a flared shape to guide the flow of pressurized air in a substantially laminar flow, as shown by the arrows in FIG. 2.

As illustrated in FIGS. 3, 3a and 3b, each protuberance 52 extends from the surface 36 of the mold 34 made of refractory material along a main elongation axis X and has at least a first substantially trapezoidal face 60 having a large base 62 joined with the internal wall of the mold and a height oriented parallel to the main elongation axis X, this first face 60 being inclined at an angle of less than 30 degrees to the internal wall of the mold, which corresponds to an angle α reproduced on the outlet opening 30, as shown in FIG. 2.

In FIGS. 3a and 3b, the reference 61 refers to holes for injecting wax into the mold. These holes 61 are located on the surface 36 and/or at the ends of the protuberances 52.

Each protuberance 52 comprises a substantially rectangular second face 64, aligned with the first face 60 along the main axis of elongation X, and joined to a small base 66 of the first face 60, this second face 64 being inclined at an angle greater than 80 degrees and less than 90 degrees to the internal wall of the mold, which corresponds to an angle β reproduced on the outlet opening 30, as may be seen in FIG. 2.

Finally, each protuberance 52 comprises two third and fourth substantially triangular lateral faces 68, 70 bordering the first and second faces 60, 64.

In this way, the first to fourth faces 60, 64, 68, 70 delimit the counter-form of the flared bowl. Preferably, to give the flow of compressed air the desired orientation, in the first embodiment of the disclosure, the spikes 33 will be arranged in contact with the protuberances 52 at the junction of the first and second faces 60 64. This results in channels 28 opening out at the bottom of the outlet openings 30, as shown in FIG. 2.

A similar positioning will be given to the internal channels 28 as part of the machining phase PH′2 of the method according to the second embodiment of the disclosure.

In both cases, it will be understood that subsequent deburring or polishing will always be required to obtain the desired surface finish for the final vane 10 from the cast blank 10′.

Regardless of the embodiment of the method used, the protuberances 52 may be formed in two different ways.

The protuberances 52 may be formed in one part with the internal walls of the mold 34 made of refractory material, for example by molding it.

Alternatively, the protuberances 52 may be fitted and attached to the internal walls 36 of the mold 34 made of refractory material.

The disclosure therefore allows to obtain a hollow turbine engine vane 10 equipped with internal channels 28 and outlet openings 30 corresponding to these channels 28.

1. A method for manufacturing a hollow turbine vane for a turbine engine, the hollow vane comprising pressure side and suction side walls, at least one of which is passed through by internal cooling channels, said method comprising at least a first molding phase using a lost-wax casting technique using a molten metal, said first molding phase comprising the following steps:
a) manufacturing at least one ceramic core defining at least one counter-form of at least one internal cavity of the vane to be manufactured,
b) manufacturing a mold made of refractory material, internal walls of which match to an external shape of the vane to be manufactured,
c) placing said core in said mold made of refractory material,
d) casting a lost wax in said mold made of refractory material between the core and the internal walls,
e) once the wax has solidified, opening the mold and removing the assembly formed by the core trapped in the solidified lost wax,
f) forming on said assembly a ceramic shell matching to an external shape of said assembly,
g) removing the lost wax from the ceramic shell,
h) casting of molten metal in a space left free between said core and said shell by the removal of the lost wax,
i) opening or destructing the ceramic shell,
j) removing the ceramic core so as to obtain a cast blank of the hollow turbine vane,
wherein, during step b), a plurality of protuberances are formed on the internal walls of the mold made of refractory material, defining counter-forms of outlet openings for said internal cooling channels, and
wherein, during step a), the core is manufactured with a plurality of spikes defining counter-forms of said internal cooling channels, said spikes being of a determined length configured so that, during step c), said spikes come into contact with said protuberances, so that, in step j), the cast blank of the hollow turbine vane directly incorporates those channels communicating with the outlet openings.

2. The manufacturing method according to claim 1, wherein each protuberance defines the counter-form of an outlet opening in the form of a flared bowl.

3. The manufacturing method according to claim 2, wherein each protuberance extends along a main elongation axis and has at least:
a first substantially trapezoidal face having a large base joined to the internal wall of the mold and a height oriented parallel to the main elongation axis, this first face being inclined at a first angle (α) of less than 30 degrees to the internal wall of the mold,
a rectangular second face, aligned with the first face along the main elongation axis and joined to a small base of the first face, this second face being inclined at a second angle (β) greater than 80 degrees and less than 90 degrees to the internal wall of the mold, and
two third and fourth triangular lateral faces bordering the first and second faces,
the first to fourth faces defining the counter-form of the flared bowl.

4. The manufacturing method according to claim 3, wherein the spikes are oriented to contact the protuberances at the junction of the first and second faces of the protuberances.

5. The manufacturing method according to claim 1, further comprising, after the first molding phase, a second machining phase, which comprises a step k) during which a bottom of the outlet openings of the cast blank of the vane is drilled in order to form said internal cooling channels therein.

6. The manufacturing method according to claim 5, wherein step k) is carried out by electro erosion using a sinker EDM tool or a drilling tool.

7. The manufacturing method according to claim 6, wherein during step k), position and displacement coordinates of the tool are expressed in a reference frame comprising 3 reference points all belonging to at least one outlet opening.

8. A mold made of refractory material for implementing a manufacturing method according to claim 1, wherein the protuberances are formed in one-part with the internal walls of the mold made of refractory material.

9. The mold according to claim 1, wherein the protuberances are fitted and attached to the internal walls of the mold made of refractory material.

10. A turbine engine vane manufactured using the method according to claim 1.
